(19) United States
(12) Patent Application Publication
(10) Pub. No.: US 2011/0119067 A1
(43) Pub. Date: May 19, 2011

(54) APPARATUS FOR SIGNAL STATE DECISION OF AUDIO SIGNAL

(75) Inventors: Seung Kwon Beack, Daejeon (KR); Tae Jin Lee, Daejeon (KR); Minje Kim, Daejeon (JP); Dae Young Jang, Daejeon (KR); Kyeongok Kang, Daejeon (KR); Jeongil Seo, Daejeon (KR); Jin Woo Hong, Daejeon (KR); Hochong Park, Seoul (KR); Young-Cheol Park, Seoul (KR)

(73) Assignees: ELECTRONICS AND TELECOMMUNICATIONS RESEARCH INSTITUTE, DAEJEON (KR); KWANGWOON UNIVERSITY INDUSTRY-ACADEMIC COLLABORATION FOUNDATION, SEOUL (KR)

(21) Appl. No.: 13/054,343

(22) PCT Filed: Jul. 14, 2009
(86) PCT No.: PCT/KR2009/003850

§ 371 Date: Jan. 14, 2011

(30) Foreign Application Priority Data
Jul. 14, 2008 (KR) 1020080068368
Jul. 7, 2009 (KR) 1020090061645

(51) Int. Cl. G10L 19/00

(52) U.S. Cl. 704/500; 704/E19.001

(57) ABSTRACT

A module capable of appropriately selecting a linear predictive coding (LPC)-based or a code excitation linear prediction (CELP)-based speech or audio encoder and a transform-based audio encoder according to a feature of an input signal is a module that performs as a bridge for overcoming a performance barrier between a conventional LPC-based encoder and an audio encoder. Also, an integral audio encoder that provides consistent audio quality regardless of a type of the input audio signal can be designed based on the module.

### TECHNICAL FIELD

The present invention relates to an audio signal state decision apparatus for obtaining a coded gain when coding an audio signal.

### BACKGROUND ART

Up to recently, audio or speech encoders have been developed based on different technical philosophy and access approaches. Particularly, the speech and audio encoders use different coding schemes, and also use different coded gains depending on a feature of an input signal. A sound encoder is designed by embodying and modulizing a process of generating a sound by using an approach based on a human vocal model, whereas an audio encoder is designed based on an auditory model representing a process of a human recognizing a sound.

Based on each of the access approaches, the speech encoder performs a linear predictive coding (LPC)-based coding on a residual signal as a core technology and applies a code excitation linear prediction (CELP) structure to the residual signal to maximize a compression rate, whereas the audio encoder applies auditory psychoacoustics in a frequency domain to maximize an audio compression rate.

However, the speech encoder has dramatic drop in performance at a low bit rate in speech and slowly improves its performance as a normal audio signal or a bit rate increases. Also, the audio encoder has serious deterioration of sound quality at a low bit rate but distinctly improves its performance as the bit rate increases.

### DISCLOSURE OF INVENTION

### Technical Goals

An aspect of the present invention provides an audio signal state decision apparatus that may appropriately select a linear predictive coding (LPC)-based or a code excitation linear prediction (CELP)-based speech or audio encoder and a transform-based audio encoder, depending on a feature of an input signal.

Another aspect of the present invention also provides an integral audio encoder that may provide consistent audio quality regardless of a type of input audio signal through a module performing as a bridge for overcoming a performance barrier between a conventional LPC based-encode and a transform-based audio encoder.

### Technical Solutions

According to an aspect of an exemplary embodiment, there is provided an apparatus of deciding a state of an audio signal, the apparatus including a signal observation unit to classify features of an input signal and to output state observation probabilities based on the classified features, and a state chain unit to output a state identifier of a frame of the input signal based on the state observation probabilities. Here, a coding unit where the frame of the input signal is coded is determined according to the state identifier.

Also, the signal state observation unit may include a feature extraction unit to respectively extract harmonic-related features and energy-related features as the features, an entropy-based decision tree unit to determine state observation probabilities of at least one of the harmonic-related features and the energy-related features by using a decision tree, and a silence state decision unit to determine a state of a frame of the input signal corresponding to the extracted features as state observation probabilities of a silence state when the energy-related feature of the extracted features is less than a predetermined threshold value (S-Thr). Here, the decision tree defines each of the state observation probabilities in a terminal node.

Also, the feature extraction unit may include a Time-to-Frequency (T/F) transformer to transform the input signal into a frequency domain through complex transform, a harmonic analyzing unit to extract the harmonic-related feature by applying, to an inverse discrete Fourier transform, a result of a predetermined operation between the transformed input signal and a conjugation operation with respect to a complex number of the transformed input signal, and an energy extracting unit to divide the transformed input signal by a sub-band unit and to extract an energy ratio for each sub-band as the energy-related feature.

Also, the harmonic analyzing unit may extract, from a function where the inverse discrete Fourier transform is applied, at least one of an absolute value of a dependent variable when an independent variable is ‘0’, an absolute value of a peak value, a number of frames from an initial frame to a frame corresponding to the peak value, and a zero crossing rate, as the harmonic-related feature.

Also, the energy extracting unit may divide the transformed input signal by the sub-band unit based on at least one of a critical bandwidth and an equivalent rectangular bandwidth.

Also, the entropy-based decision tree may determine a terminal corresponding to an inputted feature among terminal nodes of the decision tree, and outputs a probability corresponding to the determined terminal as the state observation probability.

Also, the state observation probabilities may include at least two of a steady-harmonic (SH) state observation probability, a steady-noise (SN) state observation probability, a complex-harmonic (CH) state observation probability, a complex-noise (CN) state observation probability, and a silence (Si) state.

Also, the state chain unit may determine a state sequence probability based on the state observation probabilities, may calculate an observation cost expended for observing a current frame based on the state sequence probability, and may determine the state identifier of the frame of the input signal based on the observation cost.

Also, the state chain unit may determine whether the current frame of the input signal is a noise state or a harmonic state by comparing a maximum value between an observation cost of a SH state and an observation cost of a CH state with a maximum value between an observation cost of a SN state and an observation cost of a CN state.

Also, the state chain unit may determine a state identifier of the current frame as either the SN state or the CN state by comparing the observation cost of the CH state and the observation cost of the CN state with respect to the current frame decided as the noise state.

Also, the state chain unit may determine whether a state of the current frame decided as the harmonic state is silent state, and may initiate the state sequence probability when the state of the current frame is the silent state.

Also, the state chain unit may determine whether a state of the current frame decided as the harmonic state is a silent state, and when the state of the current frame is different from the silent state, may determine the current frame as either the SH state or CH state.

Also, the state chain unit may set a weight greater than or equal to ‘0’ and less than or equal to ‘0.95’ to one of state sequence probabilities, the one state sequence probability corresponding to a state identifier of a previous frame when a state identifier of the current frame is not identical to the state identifier of the previous frame.

Also, the coding unit may include a linear predictive coding (LPC) based coding unit and a transform-based coding unit, and the frame of the input signal is inputted to the LPC based coding unit when the state identifier is a steady state and the frame of the input signal is inputted to the transform based coding unit when the state identifier is a complex state and the inputted frame is coded.

According to another aspect of an exemplary embodiment, there may be provided an apparatus of deciding a state of an audio signal, the apparatus including a feature extraction unit to extract, from an input signal, a harmonic-related feature and an energy-related feature, an entropy-based decision tree unit to determine state observation probabilities of at least one of the harmonic-related feature and the energy-related feature by using a decision tree, and a silence state decision unit to determine a state of a frame of the input signal corresponding to the extracted features as a state observation probabilities of a silence state when the energy-related feature of the extracted features is less than a predetermined threshold value (S-Thr). Here, the decision tree defines each of the state observation probabilities in a terminal node.

### Advantageous Effects

According to an embodiment of the present, there is provided an LPC-based speech or audio encoder and a transform-based audio encoder integrated in a single system and a module performing a bridge for maximizing its coding performance.

According to an embodiment of the present invention, two encoders are integrated in a single codec, and in this instance, a weak point of each encoder may be overcome by using a module. That is, the LPC-based encoder only performs coding of signals similar to speech, thereby maximizing its performance, whereas the audio encoder only performs coding of signals similar to a general audio signal, thereby maximizing a coding gain.

### BRIEF DESCRIPTION OF DRAWINGS

FIG. 1 is a block diagram illustrating an internal configuration of an audio signal state decision apparatus according to an embodiment of the present invention;

FIG. 2 is a block diagram illustrating an internal configuration of a signal state observation unit according to an embodiment of the present invention;

FIG. 3 is a block diagram illustrating an internal configuration of a feature extraction unit according to an embodiment of the present invention;

FIG. 4 is an example of a graph illustrating a value used in a harmonic analyzing unit to extract a character according to an embodiment of the present invention;

FIG. 5 is an example of a decision tree generating method that is applicable to an entropy-based decision tree unit according to an embodiment of the present invention;

FIG. 6 is a diagram illustrating a relation between states where a shift occurs through a state chain unit according to an embodiment of the present invention; and

FIG. 7 is a flowchart illustrating a method of determining an output of a state chain unit according to an embodiment of the present invention.

### BEST MODE FOR CARRYING OUT THE INVENTION

Although a few exemplary embodiments of the present invention have been shown and described, the present invention is not limited to the described exemplary embodiments, wherein like reference numerals refer to the like elements throughout.

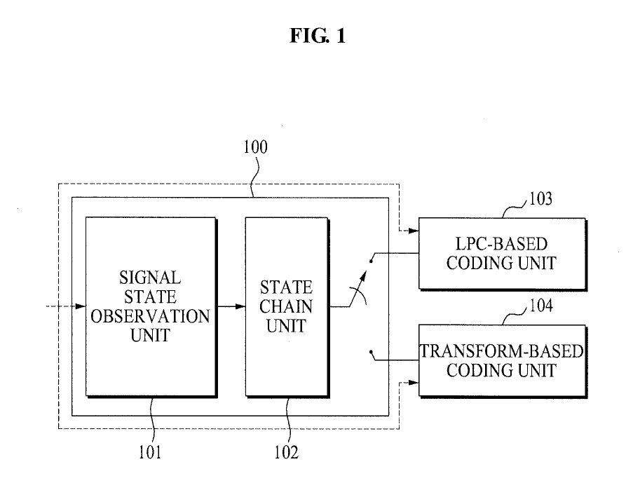

FIG. 1 is a block diagram illustrating an internal configuration of an audio signal state decision apparatus 100 according to an embodiment of the present invention. As illustrated in FIG. 1, the audio signal state decision apparatus 100 according to the present embodiment includes a signal state observation (SSO) unit 101 and a state chain unit 102.

The signal state observation unit 101 classifies features of an input signal and outputs state observation probabilities based on the features. In this instance, the input signal may include a pulse code modulation (PCM) signal. That is, the PCM signal may be inputted to the signal state observation unit 101, and the signal state observation unit 101 may classify features of the PCM signal and may output state observation probabilities based on the features. The state observation probabilities may include at least two of steady-harmonic (SM) state observation probability, a steady-noise (SN) state observation probability, a complex-harmonic (CH) state observation probability, a complex-noise (CN) state observation probability, and a silence (Si) state probability.

Here, the SH state may indicate a state of a signal section where a harmonic component of a signal is distinct and stable. A voiced speech of a speech may be included as a representative example, and sinusoid signals of a single-ton may be classified into the SH state.

The SN state may indicate a state of a signal section such as a white noise. As an example, an unvoiced speech section of the speech is basically included.

The CH state may indicate a state of a signal section where various tone components are mixed together and constructs a complex harmonic structure. As an example, play sections of general music may be included.

The CN state may indicate a state of a signal section where unstable noise components are included. Examples may include noises of surrounding environment, a signal of an attack-character in the play section of the music, and the like.

The Si state may indicate a state of a signal section where energy intensity is weak.

The signal state observation unit 101 may classify the features of the input signal, and may output a state observation probability for each state. In this instance, the outputted state observation probabilities may be defined as given in (1) through (5) below.

(1) The state observation probability for the SH state may be defined as ‘P_{SH}’

(2) The state observation probability for the SN state may be defined as ‘P_{SN}’

(3) The state observation probability for the CH state may be defined as ‘P_{CH}’

(4) The state observation probability for the CN state may be defined as ‘P_{CN}’

(5) The state observation probability for the Si state may be defined as ‘P_{Si}’

Here, the input signal may be PCM data in a frame unit, which is provided as the above-described PCM signal, and the PCM data may be expressed as given in Equation 1 below.

x(b)=[x(n), . . . ,x(n+L−1)]^{T} [Equation 1]

Here, ‘x(n)’ is a PCM data sample, ‘L’ is a length of a frame, and ‘b’ is a frame time index.

In this instance, the outputted state observation probabilities may satisfy a condition expressed as given in Equation 2 below.

P_{SH}+P_{SN}+P_{CH}+P_{CN}+P_{Si}=1 [Equation 2]

The state chain unit 102 may output a state identifier (ID) of a frame of the input signal based on the state observation probabilities. That is, the state observation probabilities outputted from the signal state observation unit 101 are inputted to the state chain unit 102, and the state chain unit 102 outputs the state ID of the frame of the corresponding signal based on the state observation probabilities. Here, the outputted ID may indicate at least one of a steady-state, such as, an SH state and an SN state, and a complex-state, such as a CH state and a SN state. In this instance, when being in a steady-state, the input PCM data may be coded by using an LPC-based coding unit 103, and when being in a complex-state, the input PCM data may be coded by using a transform-based coding unit 104. A conventional LPC-based audio encoder may be used as the LPC-based coding unit 103, and a conventional transform-based audio encoder may be used as the transform-based coding unit 104. As an example, a speech encoder based on an adaptive multi-rate (AMR) and a speech encoder based on a code excitation linear prediction (CELP) may be used as the LPC-based coding unit 103, and an audio encoder based on an AAC may be used as the transform-based coding unit 104.

Accordingly, the LPC-based coding unit 103 and the transform-based coding unit 104 may be selectively determined and coded according to the features of the input signal by using the audio signal state decision apparatus 100 according to an embodiment of the present invention, thereby acquiring a high coding rate.

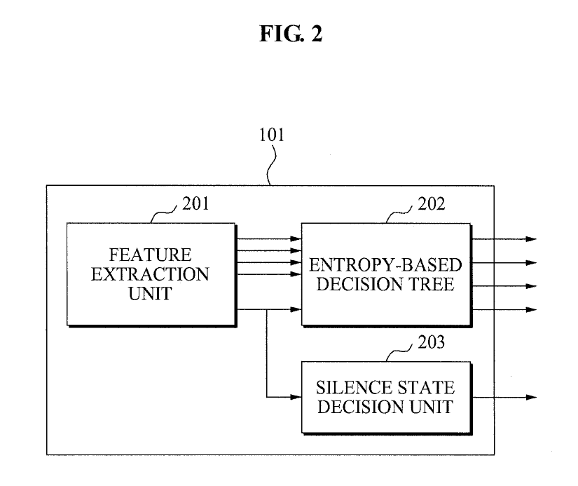

FIG. 2 is a block diagram illustrating an internal configuration of a signal state observation unit 101 according to an embodiment of the present invention. The signal state observation unit 101 according to an embodiment of the present invention may include a feature extraction unit 201, an entropy-based decision tree 202, and a silence state decision unit 203.

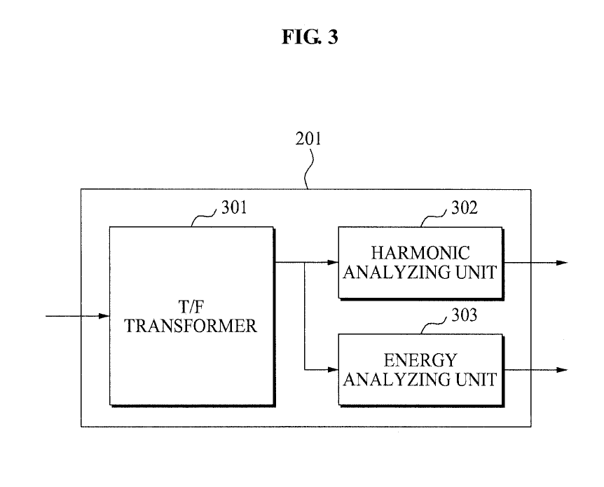

The feature extraction unit 201 respectively extracts a harmonic-related feature and an energy-related feature as a feature. The features extracted from the feature extraction unit 201 will be described in detail with reference to FIG. 3.

The entropy-based decision tree unit 202 may determine state observation probabilities of at least one of harmonic-related feature and the energy-related feature by using a decision tree. In this instance, each of the state observation probabilities is defined in a terminal node included in the decision tree.

The silence state decision unit 203 determines the state observation probabilities of the energy-related feature to enable a state of a frame of the input signal corresponding to the extracted features to be a silence state, when the energy-related feature of the extracted features is less than a predetermined threshold value (S-Thr).

Particularly, the feature extraction unit 201 extracts features including the harmonic-related feature and the energy-related feature from inputted PCM data, and the extracted features are inputted to the entropy-based decision tree unit 202 and the silence state decision unit 203. In this instance, the entropy-based decision tree unit 200 may use a decision tree for observing each state. Each of the state observation probabilities may be defined in each terminal node of the decision tree, and a method of arriving at the terminal node of the decision tree, that is, a method of obtaining state observation probabilities corresponding to features corresponding to each node may be determined based on whether the features corresponding to each node satisfies a condition.

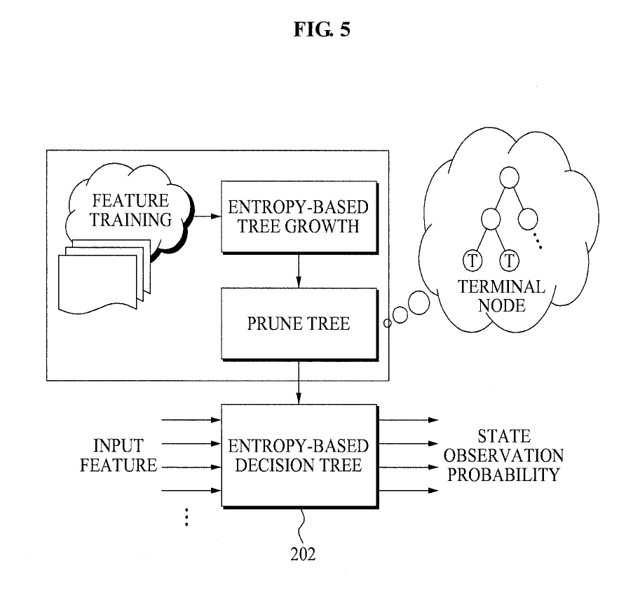

The entropy-based decision tree unit 202 will be described in detail with reference to FIG. 5.

The above-described ‘P_{SH}’, ‘P_{SN}’, ‘P_{CH}’ and ‘P_{CN}’ may be determined by the entropy-based decision tree unit 202, and ‘P_{Si}’ may be determined by the silence state decision unit 203. The silence state decision unit 203 determines that the state of the frame of the input signal as the silence state, when the energy-related feature of the extracted features is less than the predetermine threshold value (S-Thr). In this instance, the state observation probability with respect to the silence state is ‘P_{Si}=1’, and ‘P_{SH}’, ‘P_{SN}’, ‘P_{CH}’ and ‘P_{CN}’ may be constrained to be ‘0’.

FIG. 3 is a block diagram illustrating an internal configuration of a feature extraction unit 201 according to an embodiment of the present invention. Here, as illustrated in FIG. 3, the feature extraction unit 201 may include a Time-to-Frequency (T/F) transformer 301, a harmonic analyzing unit 302 and an energy analyzing unit 303.

The T/F transformer 301 may transform an input x(b) into a frequency domain, first. A complex transform is used as a transform scheme, and as an example, a discrete Fourier transform (DFT) may be used as given in Equation 3 below.

Xf(b)=DFT([x(b)o(b)]^{T})=[Xf(0), . . . ,Xf(k),Xf(2L−1)]^{T} [Equation 3]

Here, ‘o(b)’ may be expressed as

$${ }^{‵} o ( b ) = {{[ \underbrace{0 , … , 0}_{L} ]}^{T}}^{′} .$$

Also, ‘Xf(k)’ may be a frequency bin and may be expressed as a complex value, such as Xf(k)=real(Xf(k))+j·imag(Xf(k)).

Here, the harmonic analyzing unit 302 applies, to an inverse discrete Fourier transform, a result of a predetermined operation between the transformed input signal and a conjugation operation with respect to a complex number of the transformed input signal. As an example, the harmonic analyzing unit 302 may perform an operation expressed as given in Equation 4 below.

Corr(b)=IDFT(Xf(b) [symbol] conj(Xf(b)))=[Corr(0) . . . Corr(k) . . . Corr(2L−1)] [Equation 4]

Here, ‘conj’ may be a conjugation operator with respect to the complex number, and the operator ‘ [symbol] ’ may be a logical operator for each bin. Also, ‘IDFT’ may indicate the inverse discrete Fourier transform.

That is, features expressed as given in Equation 5 through Equation 8 may be extracted based on Equation 4.

fxₕ₁(b)=abs(Corr(0)) [Equation 5]

fxₕ₂(b)=abs(max(peak_peaking([Corr(1) . . . Corr(k) . . . Corr(2L−1)]^{T}))) [Equation 6]

$$\begin{matrix}{fx}_{h 1} ( b ) = abs ( Corr ( 0 ) ) & [ Equation 5 ] \\ {fx}_{h 2} ( b ) = abs ( max ( peak\_peaking ( {[ Corr ( 1 ) … Corr ( k ) … Corr ( 2 L - 1 ) ]}^{T} ) ) ) & [ Equation 6 ] \\ {fx}_{h 3} ( b ) = {argmax}_{k} ( peak\_peaking ( {[ Corr ( 1 ) … Corr ( k ) … Corr ( 2 L - 1 ) ]}^{T} ) ) & [ Equation 7 ] \\ {fx}_{h 4} ( b ) = ZCR ( Corr ( b ) ) & [ Equation 8 ]\end{matrix}$$

Here, ‘abs (•)’ is an operator being an absolute value, ‘peak_peaking’ is a function of finding a peak value of a function, and ‘ZCR( )’ is a function of calculating a zero crossing rate.

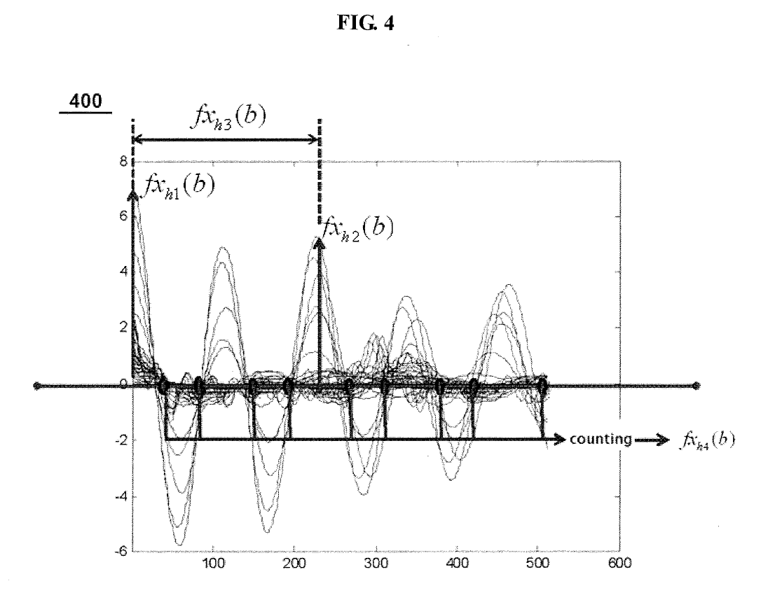

FIG. 4 is an example of a graph 400 illustrating a value used in a harmonic analyzing unit to extract a character according to an embodiment of the present invention. Here, the graph 400 may be illustrated based on the function ‘Corr(b)’ described with reference to Equation 4. Also, features ‘fxₕ₁(b)’, ‘fxₕ₂(b)’, ‘fxₕ₃(b)’ and ‘fxₕ₄(b)’ described with reference to Equation 5 through Equation 8 may be extracted as illustrated in the graph 400.

Here, ‘fxₕ₁(b)’ may be inputted to the silence state decision unit 203 described with reference to FIG. 2, and ‘P_{Si}’ may be defined according to a predetermined threshold value (S-Thr). As an example, when noise does not exist in an unvoiced speech section of an input signal, the threshold value (S-Thr) used for determining the unvoiced speech section as the silence section, may be 0.004. The predetermined threshold value (S-Thr) may be adjustable according to a signal-to-noise-ratio (SNR) of the input signal.

The energy analyzing unit 303 may group a transformed input signal into a sub-band unit and may extract a ratio between energy for each sub-band as a feature. That is, the energy analyzing unit 303 binds ‘Xf(b)’ inputted from the T/F transformer 301 by the sub-band unit, calculates energy for each sub-band, and utilizes the ratio between the calculated energies. A method of dividing the input ‘Xf(b)’ may be according to a critical bandwidth or equivalent rectangular bandwidth (ERB). As an example, the input ‘Xf(b)’ may be defined as given in Equation 9 below, when 1024 DFT is used and a boundary of the sub-band is based on the ERB.

Ab[20]=[0 2 4 7 11 15 20 26 34 44 56 71 90 113 142 178 222 277 345 430 513] [Equation 9]

Here, ‘Ab[ ]’ is arrangement information indicating an ERB boundary, and in the case of the 1024 DFT, the ERB boundary may based on Equation 9 below.

Here, an energy of a predetermined sub-band, ‘Pm(i)’, may be defined as given in Equation 10 below.

$$Pm ( i ) = {\sum }_{k = Ab [ i ]}^{Ab [ i + 1 ] - 1} {( Xf ( k ) )}^{2} ( 1 = 0 , … , 19 ) \qquad [ Equation 10 ]$$

In this instance, energy features extracted from Equation 10 may be expressed as given in Equation 11 below.

$${fx}_{e 1} ( b ) = \frac{{\sum }_{i = 0}^{i = 6} Pm ( i )}{{\sum }_{i = 7}^{i = 20} Pm ( i )} , {fx}_{e 2} ( b ) = \frac{{\sum }_{i = 2}^{i = 6} Pm ( i )}{{\sum }_{i = 7}^{i = 20} Pm ( i )} , \\ {fx}_{e 3} ( b ) = \frac{{\sum }_{i = 5}^{i = 6} Pm ( i )}{{\sum }_{i = 3}^{i = 4} Pm ( i )} , {fx}_{e 4} ( b ) = \frac{{\sum }_{i = 5}^{i = 6} Pm ( i )}{{\sum }_{i = 7}^{i = 20} Pm ( i )} , \\ {fx}_{e 5} ( b ) = \frac{{\sum }_{i = 3}^{i = 4} Pm ( i )}{{\sum }_{i = 7}^{i = 20} Pm ( i )} , {fx}_{e 6} ( b ) = \frac{{\sum }_{i = 5}^{i = 6} Pm ( i )}{{\sum }_{i = 7}^{i = 14} Pm ( i )} , \\ {fx}_{e 7} ( b ) = \frac{Pm ( 0 )}{{\sum }_{i = 6}^{i = 14} Pm ( i )} \qquad [ Equation 11 ]$$

The extracted features may be inputted to the entropy-based decision tree unit 202 and the entropy-based decision tree unit 202 may apply a decision tree to the features to output state observation probabilities of an inputted value ‘Xf(b)’.

FIG. 5 is an example of a decision tree generating method that is applicable to an entropy-based decision tree unit according to an embodiment of the present invention.

The decision tree is one of classification algorithms and a commonly used algorithm. To generate the decision tree, a training process is basically required. During the training process, sample features are extracted from training data, conditions for the sample features are generated, and the decision tree may grow depending on whether to satisfy each of the conditions. According to the present embodiment, the features extracted from the feature extraction unit 201 may be used as the sample features. In the same manner, the features extracted from the feature extraction unit 201 may be used as the sample features extracted from the training data or may be used for data classification. In this instance, the decision tree is grown and an appropriate size is generated by repeatedly performing a split process to minimize entropy of a terminal node and the decision tree, during the training process. After the decision tree is generated, branches of the decision tree which makes insufficient contribution to a final entropy are pruned to reduce complexity.

As an example, condition that is used for the split process needs to satisfy criteria as given in Equation 12 below.

Δ H̅ₜ(q)= H̅ₜ(Y)−( H̅ₗ(Y)+ H̅ᵣ(Y)) [Equation 12]

Here, ‘q’ is a condition, ‘ H̅ₜ(Y)’ is entropy in a node before performing the split process, ‘ H̅ₗ(Y)+ H̅ᵣ(Y)’ is entropy of an r-node and entropy of l-node after performing the split process. A probability used in entropy in each node may indicate a value calculated by calculating a number of sample features inputted to the node for each state and dividing the number of sample features for each state by a total number of sample features. As an example, the probability used in the entropy in each node may be calculated as given in Equation 13 below.

$${P}_{SH} ( t ) = \frac{number of Steady \text{-} Harmonic samples}{total number of samples at node ( t )} \qquad [ Equation 13 ]$$

Here, ‘number of Steady-Harmonic samples’ may be a remaining number of sample features after subtracting a number of sample features of a harmonic-state from a number of sample features of a steady state, and total number of samples at note( ) may be the number of total sample features.

In the same manner, ‘P_{SN}’, ‘P_{CH}’, ‘P_{CN}’ may be calculated.

In this instance, ‘ H̅ₜ(Y)’ may be defined as given in Equation 14 below.

H̅ₜ(Y)=Hₜ(Y)P(t)=−P(t)·(P_{SH}(t)log P_{SH}(t)+P_{SN}(t)log P_{SN}(t)+P_{CH}(t)log P_{CH}(t)+P_{CN}(t)log P_{CN}(t) [Equation 14]

Also, P(t) may be defined as given in Equation 15 below.

$$P ( t ) = \frac{total samples at node t}{total training samples} \qquad [ Equation 15 ]$$

The entropy based decision tree unit 202 may determine a corresponding terminal node with respect to features of an input value ‘Xf(b)’ from among terminal nodes of the trained decision tree, and outputs probabilities corresponding to each terminal node as ‘P_{SH}’, ‘P_{SN}’, ‘P_{CH}’ and ‘P_{CN}’.

The outputted state observation probability may be inputted to the state chain unit 102, and may generate a final state ID.

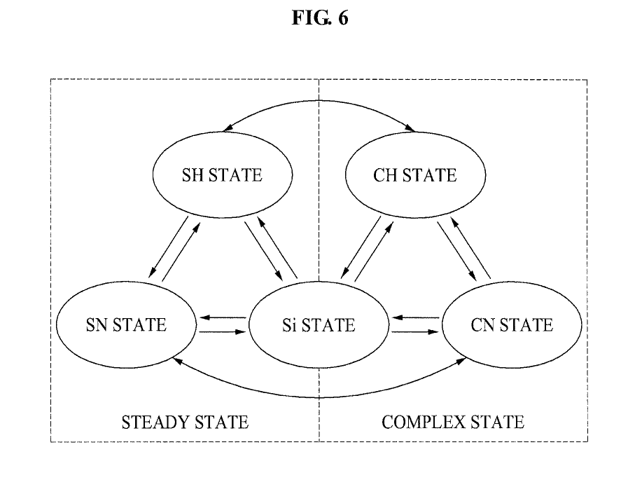

FIG. 6 is a diagram illustrating a relation between states where a shift occurs through a state chain unit according to an embodiment of the present invention. Each state may be shifted as illustrated in FIG. 6. A basic main-state may be an SH state and a CH state, and a shift between the SH state and the CH state may occur. As an example, when ‘Xf(b−1)’ is the SH state, a state observation probability with respect to ‘P_{CH}’ is significantly higher to enable ‘Xf(b)’ to be the CH state. A shift between the SH state and SN state and a shift between the CH state and CN state may freely occur.

When ‘P_{Si}=1’, a shift to silence state is always possible regardless of ‘Xf(b−1)’.

A shift between the SN state and the CN state is possible, and shift or transform between the SN state and the CN state may easily occur since the relation is depending upon a state observation probability of the main-state unlike a relation between the SH state and CH state. Here, unlike the shift, the transform may mean that although a current state is an SN state, the current state may be changed to a CN state depending on the main-state, and vice versa.

Two state sequences, namely, two vectors, of Equation 16 and Equation 17 may be defined from state observation probabilities inputted to the chain unit 102.

ₛₜₐₜₑP(b)=[P_{SH}(b),P_{SN}(b),P_{CH}(b),P_{CN}(b)]^{T} [Equation 16]

ₛₜₐₜₑC(b)=[id^{%}(b),id(b−1), . . . ,id(b−M)]^{T} [Equation 17]

Here, ‘P_{SH}(b)’, ‘P_{SN}(b)’, ‘P_{CH}(b)’ and ‘P_{CN}(b)’ respectively expressed as given in Equation 18 through Equation 21 below, and ‘M’ may indicates a number of elements of C(b)

P_{SH}(b)=[P_{SH}(b),ρₛₕ¹·P_{SH}(b−1), . . . ,ρₛₕ^{N}·P_{SH}(b-N)]^{T} [Equation 18]

P_{SN}(b)=[P_{SN}(b),ρₛₙ¹·P_{SN}(b−1), . . . ,ρₛₕ^{N}P_{SN}(b−N)]^{T} [Equation 19]

P_{CH}(b)=[P_{CH}(b),ρ_{ch}¹·P_{CH}(b−1), . . . ,ρ_{ch}^{N}·P_{CH}(b−N)]^{T} [Equation 20]

P_{CN}(b)=[P_{CN}(b),ρ_{cn}¹·P_{CN}(b−1), . . . ,ρ_{cn}^{N}·P_{CN}(b−N)]^{T} [Equation 21]

Also, ‘id(b)’ may indicate an output of a signal state observation unit 102 in a b-frame. As an example, initially, a temporary value ‘id^{%}(b)’ may be defined as given in Equation 22.

id^{%}(b)=arg max(P_{SH}(b),P_{CH}(b),P_{SN}(b),P_{CN}(b)) [Equation 22]

Here, ‘ₛₜₐₜₑP(b)’ and ‘ₛₜₐₜₑC(b)’ written in Equation 16 and Equation 17 are respectively referred to as a state sequence probability. The output of the state chain unit 102 is the final state ID, weight coefficients are 0≦ρ_{cn},ρ_{ch},ρₛₙ,ρₛₕ≦1, and a basic value is 0.95. As an example, ρ_{cn},ρ_{ch},ρₛₙ,ρₛₕ≅0 may be used when focusing on a current observation result, and ρ_{cn},ρ_{ch},ρₛₙ,ρₛₕ≅1 may be used when using a past observation result as the same statistic data.

Also, an observation cost of the current frame may be expressed as given in Equation 23 based on Equation 16 through Equation 21.

Cst_{SH}(b)=[Cst_{SH}(b),Cst_{SN}(b),Cst_{CH}(b),Cst_{CN}(b)]^{T} [Equation 23]

Here, ‘Cst_{SH}(b)’ is expressed as given in Equation 24 and Equation 26. ‘Cst_{SN}(b)’, ‘Cst_{CH}(b)’ and ‘Cst_{CN}(b)’ may also be calculated in the same manner.

CSt_{SH}(b)=α·trace(sqrt(P_{SH}(b)P_{SH}(b)^{T}))+(1−α)·_{C}P_{SH}(b) [Equation 24]

A ‘trace( )’ operator may be an operator that sums up diagonal elements in a matrix as given in Equation 25 below.

$$\begin{matrix} trace ( [ \begin{matrix}{a}_{11} & … & & {a}_{1 n} \\ & {a}_{mm} & & \\ & & ⋱ & \\ & … & & {a}_{nn}\end{matrix} ] ) = {\sum }_{i = 1}^{n} {a}_{ii} & [ Equation 25 ] \\ {}_{C}^{}{P}{}_{SH}^{} ( b ) = \frac{number of case when id == SH in C ( b )}{M} & [ Equation 26 ]\end{matrix}$$

In a determining operation, first, whether the current ‘x(b)’ is a noise state or a harmonic state may be determined based on Equation 27.

if max(Cst_{SH}(b),Cst_{CH}(b))≧max(Cst_{SN}(b),Cst_{CN}(b)),

id(b)=arg max(Cst_{SH}(b),Cst_{CH}(b)) [Equation 27]

The opposite case may also be processed in the same manner.

A post-process operation may be processed as given in Equation 28 according to state shift. Although ‘id(b)=SN’ is determined based on Equation 27, a shift of id (b)=CN is possible, when Equation 28 is satisfied. Here, ‘SN’ is a state ID indicating the steady-noise state, and ‘CN’ is an ID indicating the complex noise state.

if Cst_{CH}(b)≧Cst_{SH}(b),

id(b)=CN [Equation 28]

The opposite case may also be processed in the same manner. That is, when id(b)=SH and id(b−1)=CH, the state sequence probability may be weighted as given in Equation 29 below. Here, ‘SH’ is an ID indicating a steady-harmonic state, and ‘CH’ is an ID indicating a complex-harmonic state.

if id(b)#id(b−1),

P_{id(b-1)}(b)=P_{id(b-1)}(b)·γ [Equation 29]

Here, ‘γ’ may have a value greater than or equal to 0 and less than or equal to 0.95. That is, when a state identifier of the current frame is not identical to a state identifier of a previous frame, the state chain unit 102 may give a weight greater than ‘0’ and less than ‘0.95’ to one of state sequence probabilities, corresponding to the state identifier of the previous frame. This is to hardly control a case of a shift occurring between harmonic states.

When ‘P_{Si}=1’ is inputted to the state chain unit 102, the state sequence probability may be initiated as given in Equation 30 through Equation 34.

$$\begin{matrix}{ }_{state} C ( b ) = {[ \underbrace{0 , … , 0}_{M} ]}^{T} & [ Equation 30 ] \\ {P}_{SH} ( b ) = {[ {P}_{SH} ( b ) , {ρ}_{sh}^{1} \cdot {P}_{SH} ( b - 1 ) , … , \underbrace{0 , … , 0}_{N / 2} ]}^{T} & [ Equation 31 ] \\ {P}_{SN} ( b ) = {[ {P}_{SN} ( b ) , {ρ}_{sn}^{1} \cdot {P}_{SN} ( b - 1 ) , … , \underbrace{0 , … , 0}_{N / 2} ]}^{T} & [ Equation 32 ] \\ {P}_{CH} ( b ) = {[ {P}_{CH} ( b ) , {ρ}_{ch}^{1} \cdot {P}_{CH} ( b - 1 ) , … , \underbrace{0 , … , 0}_{N / 2} ]}^{T} & [ Equation 33 ] \\ {P}_{CN} ( b ) = {[ {P}_{CN} ( b ) , {ρ}_{cn}^{1} \cdot {P}_{CN} ( b - 1 ) , … , \underbrace{0 , … , 0}_{N / 2} ]}^{T} & [ Equation 34 ]\end{matrix}$$

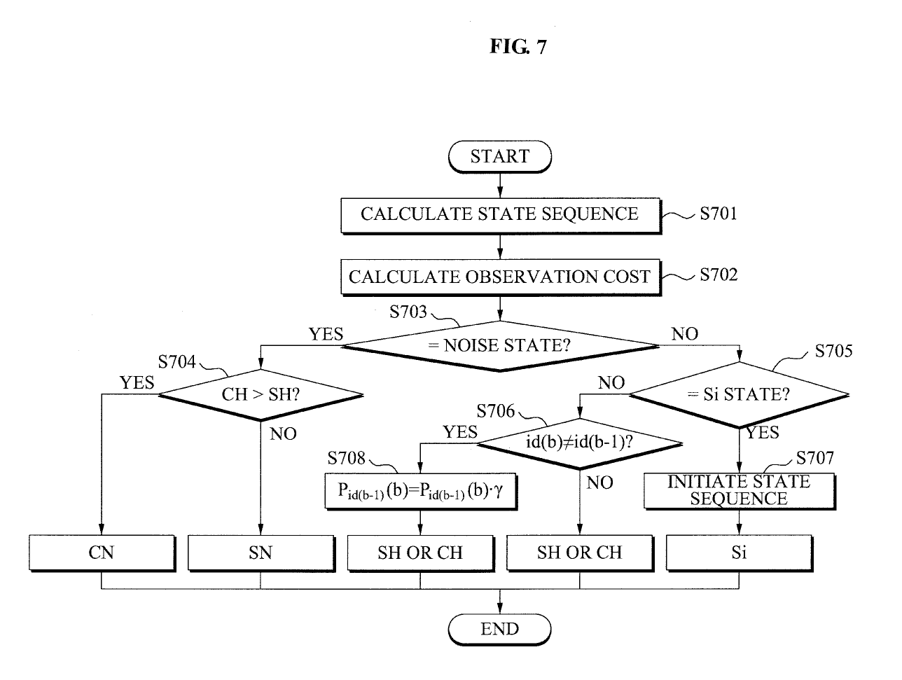

A process of determining an output of the state chain unit will be described in detail with reference to FIG. 7.

FIG. 7 is a flowchart illustrating a method of determining an output of a state chain unit according to an embodiment of the present invention.

In operation S701, the state chain unit 102 calculates a state sequence. That is, the state chain unit 102 may solve for Equation 16 and Equation 17.

In operation S702, the state chain unit 102 may calculate an observation cost. In this instance, the state chain unit 102 may calculate the observation cost based on Equation 23.

In operation S703, the state chain unit 102 determines whether a state based on state observation probabilities is a noise state, and when the state is the noise state, proceeds with operation S704, and when the state is not the noise state, proceeds with operation S705.

In operation S704, the state chain unit 102 may compare a ‘CH’ with ‘SH’, and when the ‘CH’ is greater than the ‘SH’, outputs the ‘CN’ as an ‘id(b)’ and when the ‘CH’ is less than or equal to the ‘SH’, outputs the ‘SN’ as the ‘id(b)’.

In operation S705, the state chain unit 102 determines whether the state based on the state observation probabilities is a silence state, and when the state is not a silence state, proceeds with operation S706, and when the state is the silence state, proceeds with operation S707.

In operation S706, the state chain unit 102 compares ‘id(b)’ with ‘id(b-1)’, and when the ‘id(b)’ is not identical to ‘id(b−1)’, proceeds with operation S708, and when ‘id(b)’ is identical to ‘id(b−1)’, outputs ‘SH’ or ‘CH’ as the ‘id(b)’.

In operation S708, the state chain unit 102 sets a weight of ‘γ’ to be ‘P_{id(b-1)}(b)’. That is, the state chain unit 102 may solve for Equation 28. This is to hardly control the case of shift occurring between harmonic states as described above.

In operation S707, the state chain unit 102 may initiate the state sequence. That is, the state chain unit 102 may initiate the state sequence by performing Equation 30 through Equation 34.

Referring again to FIG. 1, the LPC-based coding unit 103 and the transform-based coding unit 104 may be selectively operated according to a state ID outputted from the state chain unit 102. That is, when the state ID is ‘SH’ or ‘SN’, that is, when the state ID is a steady state, the LPC-based coding unit 103 is operated, and when the state ID is ‘CH’ or ‘CN’, that is, when the state is a complex state, the transform-based coding unit 104 is operated, thereby coding an input signal x(b).

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus of deciding a state of an audio signal, the apparatus comprising:
a signal observation unit to classify features of an input signal and to output state observation probabilities based on the classified features; and
a state chain unit to output a state identifier of a frame of the input signal based on the state observation probabilities,
wherein a coding unit where the frame of the input signal is coded is determined according to the state identifier.

2. The apparatus of claim 1, wherein the signal state observation unit comprises:
a feature extraction unit to respectively extract harmonic-related features and energy-related features as the features;
an entropy-based decision tree unit to determine state observation probabilities of at least one of the harmonic-related features and the energy-related features by using a decision tree; and
a silence state decision unit to determine a state of a frame of the input signal corresponding to the extracted features as a state observation probability of a silence state when the energy-related feature of the extracted features is less than a predetermined threshold value (S-Thr),
wherein the decision tree defines each of the state observation probabilities in a terminal node.

3. The apparatus of claim 2, wherein the feature extraction unit comprises:
a Time-to-Frequency (T/F) transformer to transform the input signal into a frequency domain through complex transform;
a harmonic analyzing unit to extract the harmonic-related feature by applying, to an inverse discrete Fourier transform, a result of a predetermined operation between the transformed input signal and a conjugation operation with respect to a complex number of the transformed input signal; and
an energy extracting unit to divide the transformed input signal by a sub-band unit and to extract an energy ratio for each sub-band as the energy-related feature.

4. The apparatus of claim 3, wherein the harmonic analyzing unit extracts, from a function where the inverse discrete Fourier transform is applied, at least one of an absolute value of a dependent variable when an independent variable is ‘0’, an absolute value of a peak value, a number of frames from an initial frame to a frame corresponding to the peak value, and a zero crossing rate, as the harmonic-related feature.

5. The apparatus of claim 3, wherein the energy extracting unit divides the transformed input signal by the sub-band unit based on at least one of a critical bandwidth and an equivalent rectangular bandwidth.

6. The apparatus of claim 2, wherein the entropy-based decision tree determines a terminal corresponding to an inputted feature among terminal nodes of the decision tree, and outputs a probability corresponding to the determined terminal as the state observation probability.

7. The apparatus of claim 1, wherein the state observation probabilities includes at least two of a steady-harmonic (SH) state observation probability, a steady-noise (SN) state observation probability, a complex-harmonic (CH) state observation probability, a complex-noise (CN) state observation probability, and a silence (Si) state.

8. The apparatus of claim 1, wherein the state chain unit determines a state sequence probability based on the state observation probabilities, calculates an observation cost expended for observing a current frame based on the state sequence probability, and determines the state identifier of the frame of the input signal based on the observation cost.

9. The apparatus of claim 8, wherein the state chain unit determines whether the current frame of the input signal is a noise state or a harmonic state by comparing a maximum value between an observation cost of a SH state and an observation cost of a CH state with a maximum value between an observation cost of a SN state and an observation cost of a CN state.

10. The apparatus of claim 9, wherein the state chain unit determines a state identifier of the current frame as either the SN state or the CN state by comparing the observation cost of the CH state and the observation cost of the CN state with respect to the current frame decided as the noise state.

11. The apparatus of claim 9, wherein the state chain unit determines whether a state of the current frame decided as the harmonic state is silent state, and initiates the state sequence probability when the state of the current frame is the silent state.

12. The apparatus of claim 9, wherein the state chain unit determines whether a state of the current frame decided as the harmonic state is a silent state, and when the state of the current frame is different from the silent state, determines the current frame as either the SH state or CH state.

13. The apparatus of claim 12, wherein the state chain unit sets a weight of one of state sequence probabilities, corresponding to be a state identifier of a previous frame when a state identifier of the current frame is not identical to the state identifier of the previous frame.

14. The apparatus of claim 11, wherein the coding unit includes a linear predictive coding (LPC) based coding unit and a transform-based coding unit, and the frame of the input signal is inputted to the LPC based coding unit when the state identifier is a steady state and the frame of the input signal is inputted to the transform based coding unit when the state identifier is a complex state and the inputted frame is coded.

15. An apparatus of deciding a state of an audio signal, the apparatus comprising:
a feature extraction unit to extract, from an input signal, harmonic-related features and energy-related features;
an entropy-based decision tree unit to determine state observation probabilities of at least one of the harmonic-related features and the energy-related features by using a decision tree; and
a silence state decision unit to determine a state of a frame of the input signal corresponding to the extracted features as a state observation probability of a silence state when the energy-related feature of the extracted features is less than a predetermined threshold value (S-Thr),
wherein the decision tree defines each of the state observation probabilities in a terminal node.

16. The apparatus of claim 15, wherein the feature extraction unit comprises:
a T/F transformer to transform the input signal into a frequency domain through complex transform;
a harmonic analyzing unit to extract the harmonic-related feature by applying, to an inverse discrete Fourier transform, a result of a predetermined operation between the transformed input signal and a conjugation operation with respect to a complex number of the transformed input signal; and
an energy extracting unit to divide the transformed input signal by a sub-band unit and to extract an energy ratio for each sub-band as the energy-related feature.

17. The apparatus of claim 15, wherein the entropy-based decision tree determines a terminal corresponding to an inputted feature among terminal nodes of the decision tree, and outputs a probability corresponding the determined terminal as the state observation probability.

18. The apparatus of claim 15, wherein the state observation probabilities includes at least two of an SH state observation probability, an SN state observation probability, a CH state observation probability, a CN state observation probability, and an Si.

19. The apparatus of claim 15, further comprising:
a state chain unit to output a state identifier of the frame of the input signal based on the state observation probabilities,
wherein a coding unit where the frame of the input signal is coded is determined according to the state identifier.

20. The apparatus of claim 19, wherein the state chain unit determines a state sequence probability based on the state observation probabilities, calculates an observation cost expended for observing a current frame based on the state sequence probability, and determines the state identifier of the frame of the input signal based on the observation cost.
